(19) United States
(12) Patent Application Publication
(10) Pub. No.: US 2007/0029808 A1
(43) Pub. Date: Feb. 8, 2007

(54) Retractable safety edge mechanism, installation method and resultant door system

(76) Inventor: Maria Wang, Shanghai (CN)

Correspondence Address: SCHWEITZER CORNMAN GROSS & BONDELL LLP, 292 MADISON AVENUE - 19th FLOOR, NEW YORK, NY, 10017, US

(21) Appl. No.: 11/450,614

(22) Filed: Jun. 9, 2006

(30) Foreign Application Priority Data
Jun. 21, 2005 (EP) EP 05 105514.3

(51) Int. Cl. E05C 21/00

(52) U.S. Cl. 292/1

(57) ABSTRACT

A retractable safety edge mechanism includes a safety edge for projecting ahead of a leading edge of a door, a link attached to the safety edge for pivotal fixation to the door, a lever mechanism for pivotal fixation to the door; and switch means disposed on one or both of the link and the lever mechanism operable by relative movement therebetween. Rotation of the lever mechanism in a retraction direction causes rotation of the link to retract the extended safety edge and the lever mechanism projects ahead of the safety edge. The safety edge mechanism may be incorporated into a powered door system.

The invention relates to the field of automatically operated sliding doors and, in particular, to a retractable safety edge mechanism for mounting on such a door, a method for installing the retractable safety edge mechanism on the door and the resultant door system obtained.

### BACKGROUND OF THE INVENTION

A conventional sliding door retractable safety edge mechanism generally includes a safety edge pivotally supported by links which in turn are rotatably mounted to the door so that the safety edge is parallel to, and projects ahead of, a leading edge of the door. In such an arrangement, if the safety edge encounters any obstruction during a dosing operation of the door it retracts and thereby the links are simultaneously rotated. This retraction of the safety edge or rotation of the support links is detected by switch means which immediately signals the halting, and preferably reopening, of the door.

It is often necessary to retract the safety edge when the door nears its fully closed position. For example, in the case of two center-opening doors it is clearly desirable to retract the safety edges so that they will not be deformed by continually bumping against each other as the doors fully close. JP-02225287-A describes a frequently used retractable safety edge mechanism that protects objects during the closing operation of the door and also retracts the safety edge when the door approaches its fully closed position. A fulcrum fixed to the door rotatably supports not only one of the links attached to the safety edge, but also a lever which is biased in an extended direction. The switch means which is provided on the link and/or the lever is operable by relative rotation therebetween. Rotation of the lever in a retraction direction causes simultaneous rotation of the link to retract the extended safety edge. The mechanism of JP-02225287-A also includes a linkage arm which, at one end, is pivotally mounted to a stationary part of the door surround and, at the other end, is pivotally mounted to the door in close proximity to the fulcrum carrying the lever and link. As the door approaches its fully closed position, the linkage arm assumes a position where a cam thereon engages the lever causing simultaneous rotation of the lever and the link in the retraction direction and thereby the safety edge is retracted.

The linkage arm is connected to and therefore adds weight to the door. Since the maximum kinetic energy of the sliding door is restricted by regulation (see for example European Standard EN 81-1:1998, §8.7.2.1.1.2 which limits the kinetic energy to 10 J), this additional weight from the linkage arm effectively reduces the maximum permissible closing speed of the door. Furthermore, the linkage arm increases both the initial and the maintenance costs of the door.

Moreover, the function of the linkage arm is essentially distance dependent as it travels with, and spans the entire path of, the door to retract the safety edge as the door approaches its fully closed position. The linkage arm assumes its active state only when the door is at a specific position along its travel path. Hence, a given linkage arm can only be used on doors having the same travel path. Accordingly, doors systems having different travel paths require different linkage arms.

Accordingly, an objective of the present invention is to overcome the problems associated with the prior art in particular, the invention seeks to reduce the number of components in a retractable safety edge mechanism without deteriorating its functionality so as to simplify installation and reduce weight, cost and complexity. Furthermore, the invention seeks to provide a retractable safety edge mechanism which can be universally applied to door systems used to close openings of different widths.

These objectives are achieved by a retractable safety edge mechanism according to the invention, a powered door system incorporating the retractable safety edge mechanism and a method for installing the retractable safety edge mechanism in a powered door system.

### BRIEF DESCRIPTION OF THE INVENTION

A retractable safety edge mechanism for use on a powered door system in accordance with the present invention comprises a safety edge for projecting ahead of a leading edge of a door, a link attached to the safety edge for pivotal fixation to the door, a lever mechanism for pivotal fixation to the door, and switch means disposed on one or both of the link and the lever mechanism operable by relative movement therebetween wherein rotation of the lever mechanism in a retraction direction causes rotation of the link to retract the extended safety edge, characterized in that the lever mechanism projects ahead of the safety edge.

Accordingly, as the door approaches its closed position, the lever mechanism which extends ahead of the safety edge will abut a door jamb (or alternatively a similar lever mounted on an opposing door of a center-opening door system) such that further movement of the door in the closing direction will cause the lever mechanism to rotate in the retraction direction thereby effecting simultaneous rotation of the link and retraction of the extended safety edge. Furthermore, if the safety edge engages with an obstruction during a closing operation of the door, the link rotates independently of the lever mechanism in the retraction direction to operate the switch means.

The retractable safety edge mechanism according to the invention commences retraction of the safety edge when the leading edge of the door reaches a specific distance from its fully closed position. That specific distance is defined by the amount to which the lever mechanism projects ahead of the leading edge. Hence, the retractable safety edge mechanism will operate effectively irrespective of the total travel path of the door, and therefore can be universally applied to door systems having different travel paths.

Preferably, the link and the lever mechanism are pivotally mounted alongside each other on a common fulcrum. Alternatively, the link can be mounted on a first fulcrum and the lever mechanism can be disposed above the link on a second fulcrum. With such an arrangement, the link and lever mechanism are in the same vertical plane enabling a reduction in the width of the retractable safety edge mechanism.

Preferably, the retractable safety edge mechanism includes a mounting plate on which the link and lever mechanism are pivotally mounted. Accordingly, the components of the retractable safety edge mechanism can be pre-mounted on the mounting plate at a factory making on site installation easier.

Preferably, the retractable safety edge mechanism further comprises a bracket for fixation to a stationary part of the door system and for abutment against the lever mechanism as the door approaches its fully opened position. Hence, when the door approaches the fully opened position, the bracket engages the lever mechanism such that further movement of the door in the opening direction will cause the lever mechanism to rotate in the retraction direction thereby effecting simultaneous rotation of the linkage and retraction of the extended safety edge.

The horizontal length of the bracket depends on the width of the panel(s) used in the door. Clearly, the bracket can be supplied with a specific length for a door having a specific panel width, however, preferably the bracket is horizontally adjustable so that the one bracket can be used for all conceivable door systems.

Preferably, a portion of the lever mechanism that projects ahead of the safety edge is positioned above the safety edge. Accordingly, the safety edge and the lever can be located in the same plane (saving space) without adversely affecting their respective functionality.

Preferably, in a powered door system incorporating the retractable safety edge mechanism the portion of the lever mechanism that projects ahead of the safety edge is contained within or above a door transom. Hence, the lever mechanism does not obstruct the opening and is not visible to people passing through the opening.

### BRIEF DESCRIPTION OF THE DRAWINGS

The present invention is herein described by way of specific examples with reference to the accompanying drawings in which:

FIG. 1 is a perspective view of a center-opening door system having doors incorporating retractable safety edge mechanisms according to a first embodiment of the invention;

FIG. 2 is a plan view of the components of the retractable safety edge mechanisms illustrated in FIG. 1;

FIG. 3 is an exploded view of section A of FIG. 2 illustrating the main components of the retractable safety edge mechanism in more detail;

FIG. 4 is a partial view of the retractable safety edge mechanism of FIG. 3 with the door in the fully opened position;

FIG. 5 is a partial view of the retractable safety edge mechanism of FIG. 3 as the door moves to an intermediate position along its travel path;

FIG. 6 is a view similar to FIG. 5 except it illustrates the situation when the safety edge encounters an obstruction during the closing operation of the door;

FIG. 7 is a partial view of the retractable safety edge mechanism of FIG. 3 with the door in the fully closed position;

FIG. 8 is a partial view of a retractable safety edge mechanism according to a second embodiment of the invention as the door moves to an intermediate position along its travel path;

FIG. 9 is a partial view of a retractable safety edge mechanism according to a third embodiment of the invention; and

FIG. 10 is a partial view of a retractable safety edge mechanism according to a fourth embodiment of the invention.

### DETAILED DESCRIPTION OF THE INVENTION

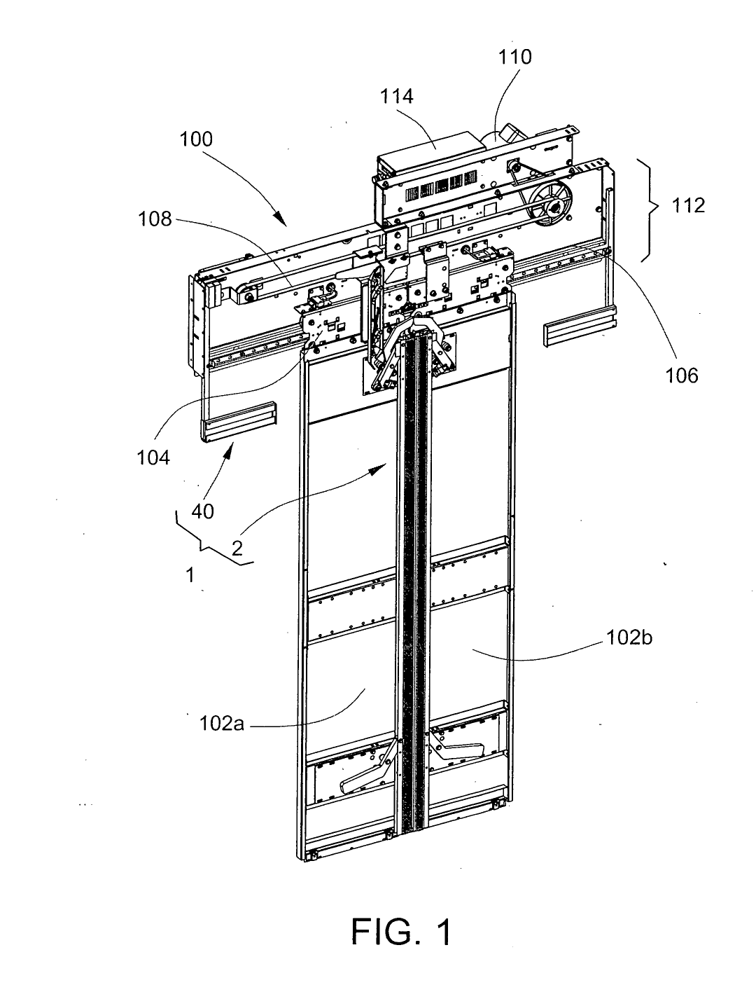

FIG. 1 illustrates a center-opening door system 100 commonly used in modern elevator installations. The door system 100 comprises a left and a right door 102a, 102b respectively which for simplicity have each been shown as consisting of a single panel. It will be readily appreciated that the invention is not limited to such a construction as it can be used equally effectively on multi-panel doors and in telescopic rather than centre-opening door systems. The doors 102a, 102b are suspended in a conventional manner by hangers 104 from a door track 106. The hangers 104 are connected to a transmission belt 108 which is driven by a motor 110 to move the door panels 102a, 102b in opposing directions. The function of the motor 110 is governed by a door controller 114. The track 106, hangers 104, transmission belt 108, motor 110 and controller 114 are generally invisible to passengers as they are all contained within or above a door transom 112 defining the uppermost part of a doorway. A retractable safety edge mechanism 1 according to the present invention is provided for each of the doors 102a, 102b.

The retractable safety edge mechanisms 1 are shown in more detail in FIG. 2, however, so as to avoid unnecessary repetition, the following description refers to the components, construction and function of only one of the retractable safety edge mechanisms 1 (the other being identical). The retractable safety edge mechanism 1 includes a safety edge 2 configured to extend substantially the full length of the door 102a, 102b and to project ahead of the leading edge of the door 102a, 102b. The safety edge 2 is supported by means of pivots 14,34 on a pair of links, the upper link being designated 8 and the lower link 28. These support links 8,28, in turn, are rotatably mounted on fulcrums 16,36 provided on mounting plates 18,38, which in use are secured to the door 102a, 102b using any conventional fastening technique. A retraction lever 22 is also pivotally mounted on the fulcrum 16 of the upper link 8. As can be clearly seen from the figure, a protruding end 23 of the retraction lever 22 extends above and ahead of the safety edge 2.

The retractable safety edge mechanism 1 also includes a bracket 40 having a vertical support 42 which in use is secured to the door transom 112 as shown in FIG. 1, and a horizontal abutment 44. Preferably the abutment 44 is extensible in the horizontal direction x and includes a bumper 46 secured to an end facing the safety edge 2. The bumper 46 can be manufactured from a sound and vibration absorbing material such as rubber.

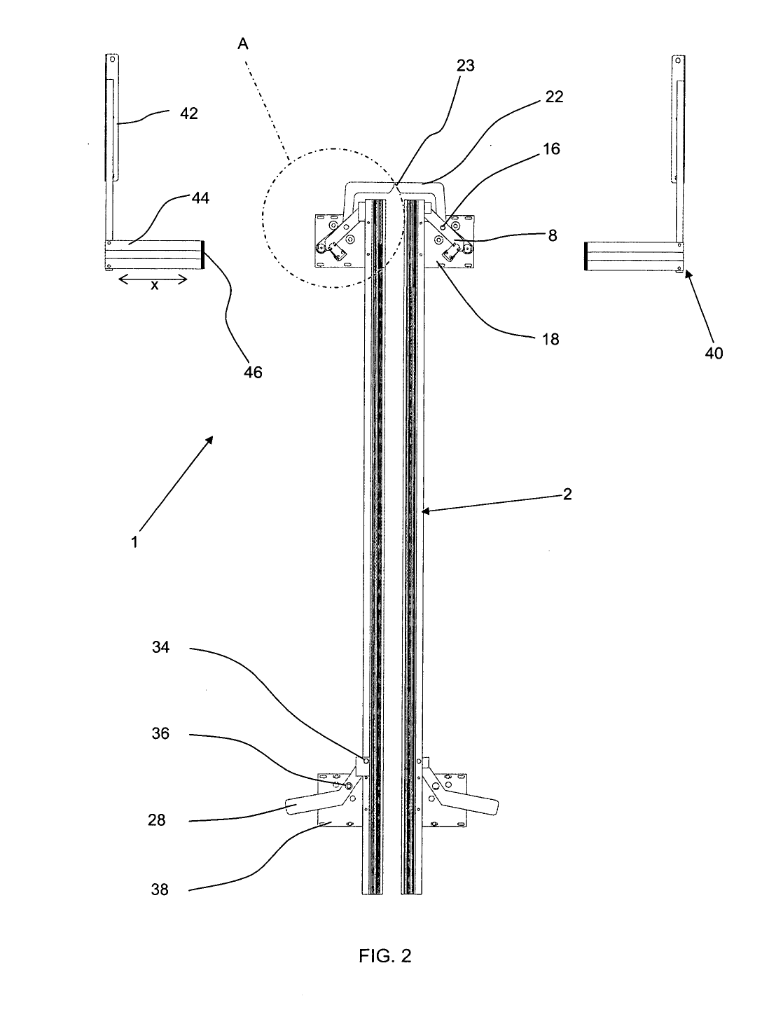

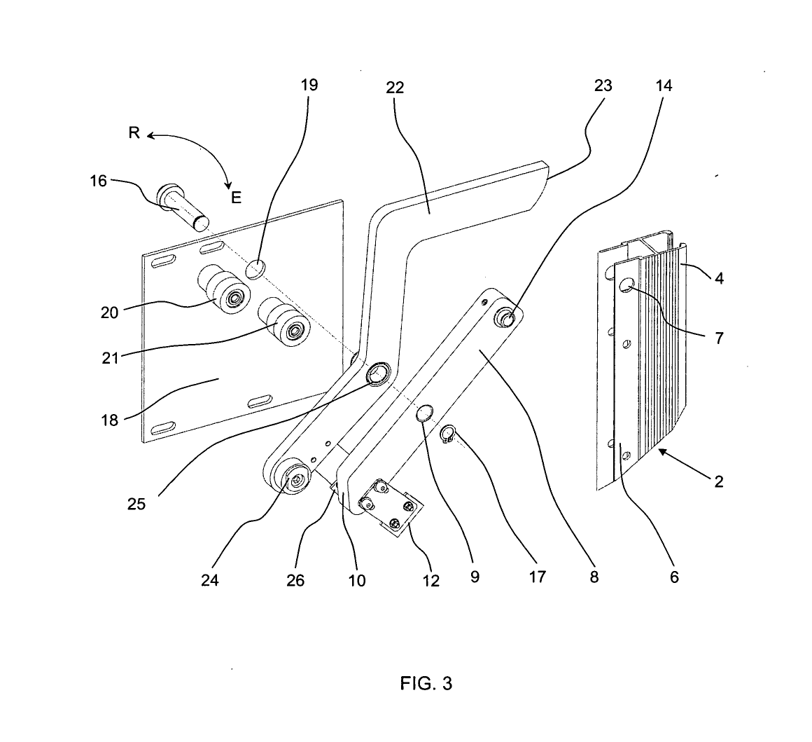

FIG. 3 is an exploded view of section A of FIG. 2 illustrating in greater detail the upper mounting plate 18 and the components of the retractable safety edge mechanism 1 attached thereto. The fulcrum 16 is inserted through a hole 19 provided in the mounting plate 18 so that a head of the fulcrum 16 abuts a rear surface of the mounting plate 18. The retraction lever 22 and the upper support link 8 are mounted, by way of corresponding holes 25,9 provided therein, on the fulcrum 16. The retraction lever 22 and the upper support link 8 are retained on, and prevented from axial movement along, the fulcrum 16 by a circlip 17. The upper mounting plate 18 also supports two stoppers 20, 21 which limit rotation of the retraction lever 22 and the upper support link 8 about the fulcrum 16 in an extension direction E and a retraction direction R, respectively.

The retraction lever 22 includes a protruding end 23 positioned above and extending ahead of the safety edge 2, a stopper 24 mounted in close proximity to an end remote to the protruding end 23, and a magnet 26 suspended underneath the retraction lever 22. The upper support link 8 includes the pivot 14 on which the safety edge 2 is mounted, a chamfered end 10 remote from the pivot 14 for engagement with the stopper 24 mounted on the retraction lever 22, and a magnetically operable contact switch 12 suspended underneath the link 8. The safety edge 2 comprises a rigid support channel 6 having a hole 7 into which the pivot 14 on the link 8 is inserted, and a deformable member 4 positioned ahead of the rigid support channel 6 for impacting with an object obstructing the path of the closing door 102a.

The center of gravity of the retraction lever 22 lies between its mounting hole 25 and the protruding end 23 (or to the right of the fulcrum 16 as shown in the FIG.). Accordingly, with no external forces acting on the retraction lever 22, gravitational force biases the lever 22 in the extension direction E to its rest position where it abuts against the upper stopper 20 on the mounting plate 18. Similarly, the weight of the safety edge 2 pivotally mounted on the support link 8 biases the link 8 in the extension direction E to its rest position where the chamfered end 10 abuts against the stop 24 on the retraction lever 22. In their respective rest positions, the lever 22 and the link 8 lie alongside each other as do the magnet 26 and the contact switch 12. This alignment of the magnet 26 with the contact switch 12 maintains the switch 12 in an ON state. In use, the contact switch 12 is connected by means of a conventional cable (not shown) to the door controller 114.

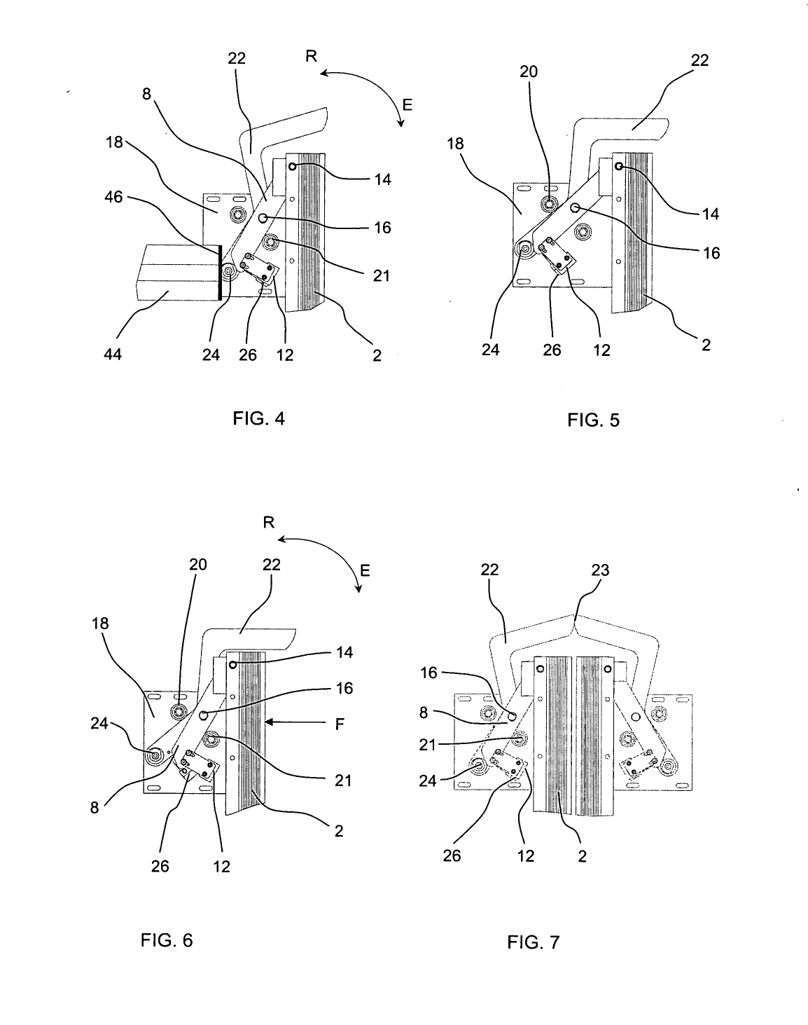

FIGS. 4 to 7 illustrate all the operating conditions and positions that the retractable safety mechanism 1 undergoes in use. FIG. 4 illustrates the retractable safety edge mechanism 1 with the door 102a at its fully opened position. As the door 102a moves to this position, the bumper 46 mounted on the horizontal abutment 44 of the bracket 40 engages with the stop 24 mounted on the retraction lever 22 (or alternatively, the bumper 46 can be positioned for direct engagement with the retraction lever 22) causing simultaneous rotation of the lever 22 and the support link 8 in the retraction direction R about the fulcrum 16. Since there is no relative rotation between the lever 22 and the link 8, the magnet 26 and the contact switch 12 remain in alignment during this operation and therefore the switch 12 remains ON. Thereby, the safety edge 2 is retracted without the switch 12 signalling the door controller 114 to halt or reverse the motor 110.

FIG. 5 illustrates the retractable safety edge mechanism 1 with the door 102a in an intermediate position. In this position, no external forces act of the retractable safety edge mechanism 1 and thus both the retraction lever 22 and the support link 8 are at their rest positions with the lever 22 abutting the upper stopper 20 mounted on the mounting plate 18 and the chamfered end 10 of the support link 8 resting against the stop 24 of the retraction lever 22. Here again, there is no relative rotation between the lever 22 and the link 8 and therefore the contact switch 12 remains ON permitting normal operation of the controller 114.

FIG. 6 illustrates the retractable safety edge mechanism 1 when the safety edge 2 comes into contact with an obstruction, represented by a force F, during a closing operation of the door 102a. The force F acting on the safety edge is translated into rotation of the support link 8 in the retraction direction R about the fulcrum 16. However, the retraction lever 22 remains in its rest position in abutment against the upper stopper 20 mounted on the mounting plate 18. This relative rotation between the link 8 and the lever 22 brings the magnet 26 and the contact switch 12 out of alignment with the switch thereby sending an OFF signal to the door controller 114 which immediately halts or reverses the operation of motor 110. Accordingly, the door 102a is stopped or re-opened to prevent further movement against the obstruction.

FIG. 7 illustrates the retractable safety edge mechanism 1 with the door 102a at its fully closed position. As the door 102a approaches this position (as shown in FIG. 2), the protruding end 23 of the retraction lever 22 comes into contact with the corresponding protruding end of the retraction lever mounted on the opposing door 102b. This causes simultaneous rotation of the lever 22 and the link 8 in the retraction direction R. Since there is no relative rotation between the lever 22 and the link 8, the magnet 26 and the contact switch 12 remain in alignment during this operation and therefore the switch 12 remains ON. Thereby, the safety edge 2 is retracted without the switch 12 signalling the door controller 114 to halt or reverse the motor 110.

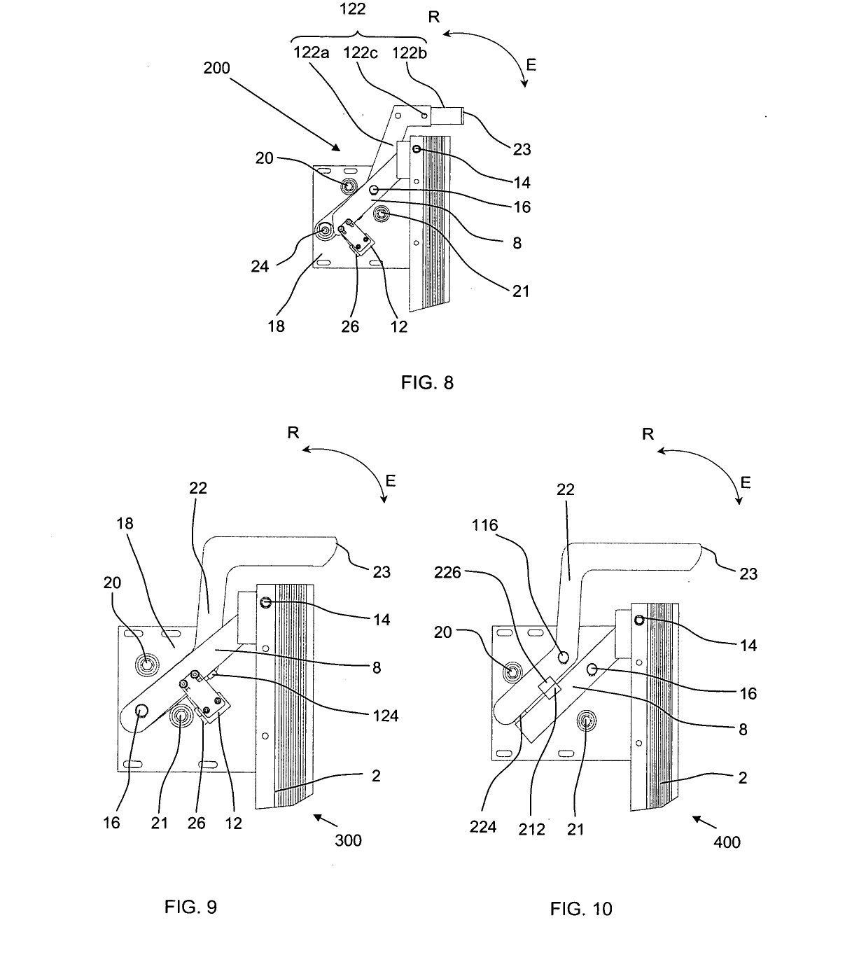

The skilled person will appreciate that many different variations are possible to achieve the same objective. For example, any lever mechanism can be used in place of the retraction lever 22 so long as it is capable of translating a horizontal force exerted on the protruding end 23 into a rotation of the link 8 about the fulcrum 16 in the retraction direction R to retract the safety edge 2. Such an example is given in FIG. 8 which illustrates a partial view of a retractable safety edge mechanism 200 according to a second embodiment of the invention. The figure generally corresponds with FIG. 5 in that it shows the retractable safety edge mechanism 200 with the door 102a in an intermediate position. However, instead of having a single lever 22 mounted on the fulcrum 16, the lever mechanism 122 comprises a first lever 122a mounted on the fulcrum 16 and a self-levelling second lever 122b mounted on a frictionless pivot 122c provided on the first lever 122a. In the position shown, no external forces act of the retractable safety edge mechanism 200 and thus both the first lever 122a and the support link 8 are at their rest positions with the first lever 22 abutting the upper stopper 20 mounted on the mounting plate 18 and the chamfered end 10 of the support link 8 resting against the stop 24 of first lever 22. As the door 102a approaches the fully closed position, the protruding end 23 of the self-levelling second lever 122b comes into contact with the corresponding protruding end of the retraction lever mounted on the opposing door 102b. Although the second lever 122b remains substantially horizontal during further movement of the door 102a in the closing direction, it transmits horizontal force through the pivot 122c to the first lever 122a causing simultaneous rotation of the first lever 122a and the support link 8 in the retraction direction R. As in the previous embodiment, the magnet 26 and the contact switch 12 remain in alignment for all operating conditions except for when the safety edge 2 comes into contact with an obstruction during a closing operation of the door 102a. Here again, the force F representative of the obstruction causes independent rotation of the link 8 in the retraction direction R bringing the magnet 26 and the contact switch 12 out of alignment and causing the door controller 114 to immediately halt or reverse the operation of motor 110.

FIG. 9 is a partial view of a retractable safety edge mechanism 300 according to a third embodiment of the invention. Instead of providing the fulcrum 16 at an intermediate along the retraction lever 22 and the support link 8, the fulcrum 16 of the present embodiment is disposed on the lever 22 at an end remote from the protruding end 23 and on the link 8 at an end remote from the safety edge mounting pivot 14. In the rest position as shown, no external forces act of the retractable safety edge mechanism 300 and thus both the retraction lever 22 and the support link 8 are at their rest positions with the lever 22 abutting the lower stopper 21 mounted on the mounting plate 18 and the support link 8 resting against a bracket 124 extending from the lever 22 underneath the link 8. The bracket 124 ensures simultaneous rotation of the lever 22 and the link 8 in the retraction direction R as the door 102a approaches its fully closed position. If the safety edge 2 engages with an obstruction during a closing operation of the door 102a, the link 8 rotates independently of the lever 22 in the retraction direction causing the switch 12 to signal the door controller 114 to immediately haft or reverse the operation of motor 110. Although the retractable safety edge mechanism 300 of the present embodiment cannot be used to retract the safety edge 2 when the door 102a approaches its fully opened position (and therefore the bracket 40 is redundant), the skilled person will appreciate that with minor modification to the lever 22 this function can be accommodated. In particular, if the lever 22 was extended beyond the fulcrum 16 and the link 8 to provide an abutment surface for the bumper 46 on the bracket 40, then as the door 102a approaches its fully opened position, the bumper 46 will engage with the lever 22 causing simultaneous rotation of the lever 22 and the link 8 in the retraction direction R.

In the previously described embodiments, the lever mechanism 22,122 is always disposed alongside the link 8 on the same fulcrum 16. FIG. 10 is a partial view of a retractable safety edge mechanism 400 according to a fourth embodiment of the invention wherein the retraction lever 22 is disposed on a second fulcrum 116 above the support link 8 within the same vertical plane. In the rest position as shown, no external forces act of the retractable safety edge mechanism 400 and thus both the retraction lever 22 and the support link 8 are at their rest positions with the lever 22 abutting the upper stopper 20 mounted on the mounting plate 18 and the support link 8 resting against an abutment 224 mounded on the underside of the lever 22. As the door 102a approaches its fully opened position, the bumper 46 mounted on the horizontal abutment 44 of the bracket 40 engages with the retraction lever 22 causing simultaneous movement of the lever 22 and the support link 8 in the retraction direction R about their respective fulcrums 116,16. The same simultaneous movement is exhibited when the door 102a approaches its fully closed position. If the safety edge 2 engages with an obstruction during a closing operation of the door 102a, the link 8 rotates independently of the lever 22 in the retraction direction R. This independent rotation of the link 8 breaks a contact between a switch 212 mounted on the link 8 and a switch operator 226 mounted on the lever 22 causing the switch 12 to signal the door controller 114 to immediately halt or reverse the operation of motor 110.

In all of the preferred embodiments described, the lever mechanism 22,122 is biased by gravity in the extension direction E. However, it is equally feasible to bias the lever mechanism 22,122 using a resilient member such as a spring. Furthermore, as well established by the prior art, a spring can also provided on the link 8 to partially counteract the weight of the safety edge 2.

The invention has been specifically described for use on a center-opening door system 100. However, the skilled person will easily acknowledge that the invention is equally applicable to door systems 100 incorporating a single telescopic door. In such a case, as the door 102a approaches its fully closed position (where the leading edge lies next to a doorjamb), the protruding end 23 of the lever mechanism 22,122 would abut the door jamb such that further movement of the door in the closing direction will cause simultaneous rotation of the lever mechanism 22,122 and link 8 to retract the safety edge 2.

Instead of mounting the lever mechanism 22,122 for engagement with the upper support link 8, it is technically feasible (although not as practical) to mount the lever mechanism 22,122 on the lower mounting plate 38 for engagement with the lower support link 28.

I claim:

1. A retractable safety edge mechanism for use on a powered door system, comprising:
a safety edge for projecting ahead of a leading edge of a door;
a link attached to the safety edge for pivotal fixation to the door;
a lever mechanism for pivotal fixation to the door; and
switch means disposed on at least one of the link and the lever mechanism operable by relative movement therebetween,
wherein rotation of the lever mechanism in a retraction direction causes rotation of the link to retract the extended safety edge,
characterized in that the lever mechanism projects ahead of the safety edge.

2. A retractable safety edge mechanism according to claim 1, wherein the link and the lever mechanism are pivotally mounted alongside each other on a common fulcrum.

3. A retractable safety edge mechanism according to claim 1, wherein the link is pivotally mounted on a first fulcrum and the lever mechanism is disposed above the link on a second fulcrum.

4. A retractable safety edge mechanism according to claim 2, further comprising a mounting plate to which the fulcrum is affixed.

5. A retractable safety edge mechanism according to claim 3, further comprising a mounting plate to which each fulcrum is affixed.

6. A retractable safety edge mechanism according to claim 1, 2, 3, 4 or 5, further comprising a bracket for fixation to a stationary part of the door system and for abutment against the lever mechanism as the door approaches a fully opened position.

7. A retractable safety edge mechanism according to claim 6, wherein the bracket is horizontally adjustable.

8. A retractable safety edge mechanism according to claim 1, 2, 3, 4 or 5 wherein a portion of the lever mechanism that projects ahead of the safety edge is positioned above the safety edge.

9. A powered door system comprising:
a door;
a motor to drive the door between fully opened and fully closed positions;
a controller governing the motor, and
a retractable safety edge mechanism including a safety edge projecting ahead of a leading edge of the door, a link attached to the safety edge and pivotally mounted on the door, a lever mechanism pivotally mounted on the door, and switch means connected to the controller and disposed on at least one of the link and the lever mechanism operable by relative movement therebetween,
wherein rotation of the lever mechanism in a retraction direction causes rotation of the link to retract the extended safety edge,
characterized in that the lever mechanism projects ahead of the safety edge.

10. A powered door system according to claim 9, wherein a portion of the lever mechanism that projects ahead of the safety edge is contained within or above a door transom.

11. A method for installing a retractable safety edge mechanism in a powered door system, comprising:
pivotally mounting a link on a door,
mounting a safety edge to the link to project ahead of a leading edge of the door;
pivotally mounting a lever mechanism on the door,
providing switch means on one or both of the link and the lever mechanism operable by relative movement therebetween; and
connecting the switch means to a door controller,
wherein rotation of the lever mechanism in a retraction direction causes rotation of the link to retract the extended safety edge,
characterized in that the lever mechanism is mounted on the door such that it projects ahead of the safety edge.
